(19) United States
(12) Patent Application Publication
(10) Pub. No.: US 2004/0019587 A1
(43) Pub. Date: Jan. 29, 2004

(54) Method and device for processing a query in a database management system

(76) Inventors: You-Chin Fuh, San Jose, CA (US); Namik Hrle, Boeblingen (DE)

Correspondence Address: SAWYER LAW GROUP LLP, P O BOX 51418, PALO ALTO, CA, 94303, US

(21) Appl. No.: 10/418,442

(22) Filed: Apr. 16, 2003

(30) Foreign Application Priority Data
Jul. 25, 2002 (DE) 02102058.1

(51) Int. Cl. G06F 17/30

(52) U.S. Cl. 707/2

(57) ABSTRACT

According to one aspect of the present invention, a method is provided for processing a query in a database management system that generates an access plan to retrieve desired data from computer storage in response to the query. An identification is derived from at least a portion of a received query or representation thereof. The access plan is generated in consideration of a hint associated with the identification, if such a hint is available from a repository of hints.

### FIELD OF THE INVENT1ON

This invention relates generally to database management systems and, more particularly, to efficient evaluation of SQL statements processed in relational database management systems.

### BACKGROUND OF THE INVENT1ON

Information is frequently stored in computer processing systems in the form of a relational database. A relational database stores information as a collection of tables having interrelated columns and rows. A relational database management system (RDBMS) provides a user interface to store and retrieve the information and provides a query methodology that permits table operations to be performed on the data. One such RDBMS interface is the Structured Query Language (SQL) interface, which permits users to formulate operations on the data tables either interactively, or through batch file processing, or embedded in host languages such as C, COBOL, or the like.

SQL provides table operations with which users can request database information and form one or more new tables out of the operation results. Data from multiple tables, or views, can be linked to perform complex sets of table operations with a single statement. The table operations are specified in SQL statements called queries. One typical SQL operation in a query is the “SELECT” operation, which retrieves table rows and columns that meet a specified selection parameter. Another operation permitted by SQL is the “JOIN” operation, which concatenates all or part of two or more tables to create a new resulting table. For example, a query might produce a table that contains the names of all supervisory employees who live in a given city, and might do so by specifying a SELECT operation to retrieve employee names and resident cities from one table, and then performing a JOIN of that data after a SELECT operation to retrieve employee names and job titles from another table.

An SQL query generally includes at least one predicate, which is an SQL expression that can assume a logical value of TRUE, FALSE, or UNKNOWN. A predicate typically either specifies a data range, tests for an existence condition, tests for equivalence, or performs a similar table comparison operation. In an SQL system, a query is received through the SQL interface and is received by an SQL processor that rewrites the query from the input format provided by the user into generally standard SQL language, and also may include optimization processing performed by a query optimizer. An SQL query may be equivalently expressed in many different ways. The query optimizer typically chooses from among alternative combinations of SQL operators to ensure a query that may be more efficiently evaluated. For example, the SQL optimizer typically can determine how to organize intermediate results (intermediate tables) so data operations during evaluation are carried out with maximum efficiency.

To evaluate a query, an SQL access plan is generated by the SQL processor from the parsed, optimized SQL input. To generate an access plan, the SQL processor considers the available access paths to the data and considers system statistics on the data to be accessed to select what it considers to be the most efficient access path to evaluate the query and retrieve the results. In considering the available access paths, the processor checks table indexes, sequential read operations needed, and the like to determine how it will retrieve data. The system statistics considered in choosing from available access paths include statistics on the size of tables, the number of distinct values in columns of tables, the network locations of tables, and the like. Consideration of the available access paths and the system statistics yields the single access path determined to be the most efficient, which is selected for the access plan. In this way, the SQL processor “binds” the access path to the query. Finally, the SQL interface executes the optimized query plan, retrieves the data, and provides the results to the user.

In some circumstances, it might be necessary to “rebind” the access path to a query. For example, the SQL application may have been changed, such as by adding new types of queries to the application. The attributes of the data tables may have changed, thereby changing the manner of specifying the access path. The user may want to change the query being evaluated. Even database maintenance can create a need for rebinding the access path to a query. For each of these types of changes, it may be necessary to rebind the access path to a query.

When a rebind operation is performed, the access path of each query in an application is determined anew. This exposes a query to access path changes that might result in reduced performance. That is, because of the changes described above, a prior access path associated with a query might be more efficient than the new access path selected by the query processor, thereby reducing the query evaluation performance. Such a performance reduction may be intolerable in many operating environments where response times are critical and must be maintained. Thus, it may be desirable to select or influence the access path to be used in retrieving data.

Another circumstance for influencing the access path to be used occurs during development of new RDBMS applications. Generally, all query optimizers have limitations that can impede the selection of the most efficient access path. Under circumstances where the known non-optimal selection occurs, it would be advantageous to direct the query optimizer to make the “correct” or more nearly optimal choice.

Finally, it may be advantageous to specify access paths in conjunction with development and testing of new database functions. For example, by specifying access paths, particular query plans can be exercised and regular operation can be optimized. Moreover, known problems with query plans or query statements can be re-created and solved by investigating different access paths. For all these reasons, it can be beneficial to influence the access path to be used by the SQL optimizer.

Conventionally, it is possible to influence the access path selected by the query optimizer to retrieve data from desired table locations by providing the query optimizer with database statistics that likely will cause it to select the desired access path. Unfortunately, the access path that ultimately will be used by the optimizer cannot be specified with great precision using this method. Alternatively, some RDBMS interfaces permit the insertion of comments or “hints” in a query so that certain aspects of the access path for retrieval are specified for the optimizer. For example, it might be possible to specify “USE INDEX—1” in a query to force a table index (such as index—1) to be used during a query evaluation step. Such comments are useful primarily with rather simple queries, and like the statistics “trick” are somewhat limited in their ability to precisely specify the desired access path.

For example, from U. S. Pat. No. 5,940,819 a method and system for processing a query in a relational database management system is known. A query processor operating responds to an existing query binding function, through which the user indicates that an access plan will be specified, whereby the inclusion of a BIND₁₃ OPT1ON value in the query received from the user will trigger the special processing. The desired access path can then be received and implemented by the processor. In addition, the processor can report to the user on the access path being utilized by the optimizer, providing the user with the option of using that access path or substituting a different path. In particular, the query optimizer responds to an indication that the user wants to specify an access path by accepting that path, validating the path, and then utilizing the user-specified path, or utilizing default processor-selected path values if the user has specified invalid parameters. The query optimizer optionally reports the access path being utilized, whether the access path was specified by the user or was selected by the optimizer, to provide an access path explanation. In the case of a user-specified access path, the optimizer in the course of its normal operation may automatically set some parameters not specified by the user. In this way, the optimizer permits precise user specification of access paths and validation of the user-selected access path with minimal modification to the user interface.

The existing systems, however, provide application-dependent ways of specifying optimizer hints, i.e., the hints are specified by and dependent on an application. Thus it is disadvantageously necessary to change the application and/or to update the optimizer's input to improve database performance. For example, the prior art must find all the places in an external application where a problem statement is coded, and modify the statement in all those places.

### SUMMARY OF THE INVENT1ON

According to one aspect of the present invention, a method is provided for processing a query in a database management system that generates an access plan to retrieve desired data from computer storage in response to the query. An identification is derived from at least a portion of a received query or representation thereof. The access plan is generated in consideration of a hint associated with the identification, if such a hint is available from a repository of hints.

In another aspect of the present invention, a device for processing a query in a database management system that generates an access plan to retrieve desired data from computer storage in response to the query, includes a deriving component for deriving an identification from at least a portion of a representation of a received query, and a generating component for generating the access plan in consideration of a hint associated with said identification, said hint found in a repository of hints.

In another aspect of the present invention, a computer readable medium includes program instructions for causing a computer to perform a method including deriving an identification from at least a portion of a received predetermined representation of a query, accessing a repository of user-specified hints in order to find a hint associated with the identification, and generating the access plan in consideration of the user-specified hint, if a user-specified hint could be retrieved from the repository.

The present invention advantageously provides an application independent way of specifying optimizer hints, i.e., the hints are stored outside of the application itself. Advantageously, according to the present invention, it is unnecessary to change the application and/or to update the optimizer's input, i.e. database objects statistics, to improve database performance.

A better understanding of these and other embodiments of the present invention, and advantages thereof, can be obtained with reference to the following drawings and description of the preferred embodiments.

### BRIEF DESCRIPT1ON OF THE DRAWINGS

FIG. 1 shows a block diagram illustrating a general overview of query processing in which the method according to the present invention may be used;

FIG. 2 shows a flowchart of the method in accordance with the present invention; and

FIG. 3 shows a block diagram illustrating a database management system in a computer system in accordance with the present invention; and

FIG. 4 shows an example of how hints can be specified using database tables to store the specification in accordance with the present invention.

### DETAILED DESCRIPT1ON

The present invention provides a solution allowing optimizer hints to be specified independently of external applications. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

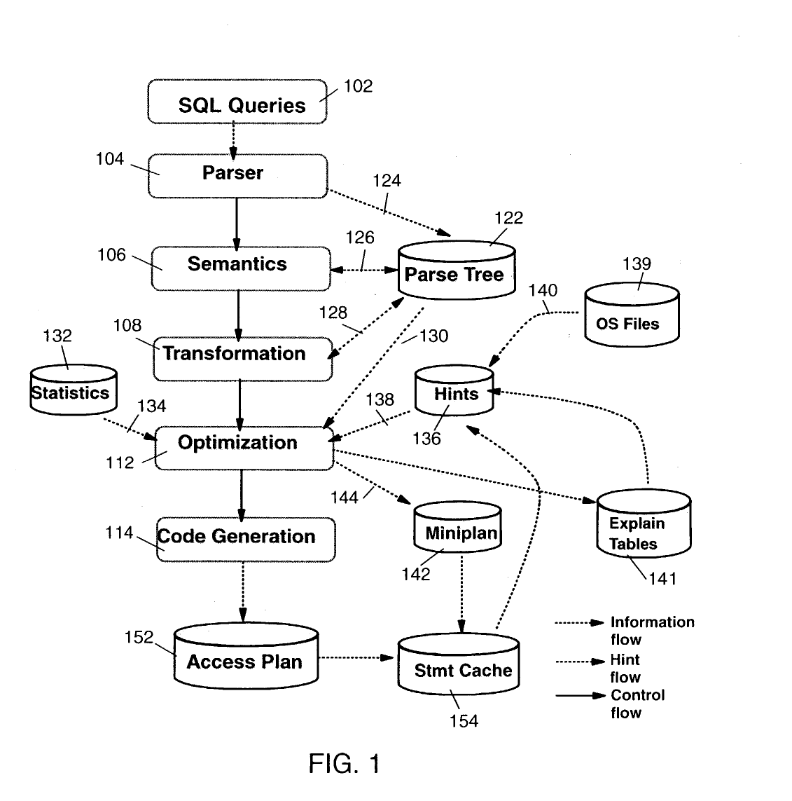

Now with reference to FIG. 1, there is depicted a block diagram illustrating a general overview of query processing in which the method according to the present invention may be used. Each SQL query 102 is treated by a series of components, which each perform particular functions, there are a parser 104, a semantics unit 106, a transformation unit 108, an optimization unit 112 and a code generation unit 114.

The parser 104 takes the SQL query 102 as input, parses the statement text, performs the syntax checking and creates the abstract representation of the query statement in the form of an internal data structure known as “Parse Tree” 122, as illustrated by the dotted arrow 124. The parse tree 122 is traversed by other components of the query compiler in the to subsequent processing steps.

The semantics unit 106 traverses the parse tree 122 and performs semantic checking (arrow 126). Any semantic restriction defined in the language specification is enforced by this component. As the result of the semantic checking, the type information and the catalog information are associated with the parse tree 122 for further processing.

The transformation unit 108 applies query transformation rules to the parse tree 122, as illustrated by arrow 128. Each rule is defined by a pattern-matching condition and a parse tree transformation. These transformation rules, if applicable, result in a semantically equivalent parse tree, which is more ready for query optimization.

The optimization unit 112 takes the parse tree 122 (arrow 130), statistic information 132 of the database objects (arrow 134) and, optionally, optimization hints 136 (arrow 138) as input. The hints 136 may be retrieved from an operating system file 139 (arrow 140). Sophisticated algorithms are employed to derive the 'optimal'access path for the underlying query 102. The access path for the SQL query 102 is represented in the form of a different data structure. In DB2 for z/OS by IBM Corporation, it is referred to as “mini plans” 142 (arrow 144).

Without a hint, the optimization unit 112 makes all the decision regarding the selection of access methods, the join types and the join sequences. In general, skilled users use hints 136, in order to dictate certain decisions that are typically made by the optimizer. According to the present invention the optimizing unit is adapted to allow the specification of hints 136 without the need of modifying an external application that invokes the SQL query 102. In other words, the present invention proposes a way of separating the specification of the hint from the application. More details on this will follow.

The code generation unit 114 uses the “mini plans” 142 for the generation of the executable code, also called access plan 152. The executable code can be either an object module in machine language or intermediate code ready for interpretation by the SQL runtime component (not shown in this diagram).

In many existing implementations, the mini plans and the executable code are cached for dynamic SQL statements for better bind performance in a cache unit 154.

The algorithm for the selection and application of the hints 136 takes the following steps: First, optimization hints 136 are created. Then, the hints 136 are associated with the corresponding query 102, and later in operation, the respective hints 136 are selected.

As to the creation of optimization hints 136, the optimization hints 136 may be created either by a client application, by the optimization unit 112 as the result of explaining a certain query 102 or by a query compiler (not shown) as the result of dynamic statement caching. The optimization hints 136, after their creation may be stored in the form of an OS (Operating System) file 139, an SQL table or an in-memory data structure (not shown).

As to the association of the hints 136 and the corresponding queries 102, the hints 136 and the corresponding queries are each associated by a unique statement ID (identification), which is obtained by applying certain transformation to the statement text or a representation thereof. The statement ID may be created at the time the hint is created and may be stored with the hint. Depending on how the hint is created, the statement ID can be created either by the application, the optimizer or the query compiler.

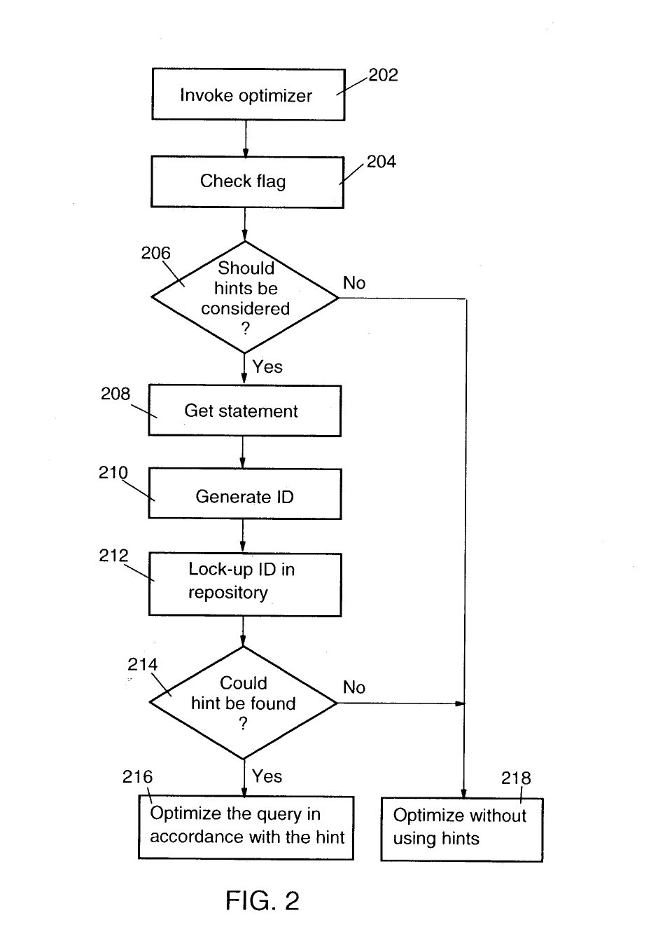

As to the selection of the hint and with reference to FIG. 2, when the optimization unit 112 is invoked (block 202), the optimizer first checks whether the hint will be considered at all (block 204). This is normally specified via a flag, such as a system parameter, which may be initialized at the system start-up time and may be altered subsequently via certain commands provided by the DBMS. If the flag indicates that hints should be considered (block 206), the statement text or a representation thereof is retrieved (block 208). Subsequently, a search key, i.e., a unique identification, for the look-up is obtained by applying the same transformation to the statement text or a representation thereof as how the unique statement ID was created at the hint creation time (block 210). Then, the source of the hint, e.g., OS file, SQL table or internal memory, is then looked up for checking the existence of the hint for the underlying query (212). If the hint is found (block 214), the optimizer will optimized the query as specified by the hint (block 216). Otherwise, optimizer will proceed as it is (218). This also happens, if the flag indicates that hints should not be considered (block 206).

Advantageously, this way, the specification of the hint is completely separated from the application. In many scenarios in which application servers such as SAP, PeopleSoft, Siebel, etc. are involved, the method and device in accordance with the present invention can advantageously be used for SQL performance tuning through hints. The SQL queries, which are generated by the underlying application server or the application code, can be kept unchanged.

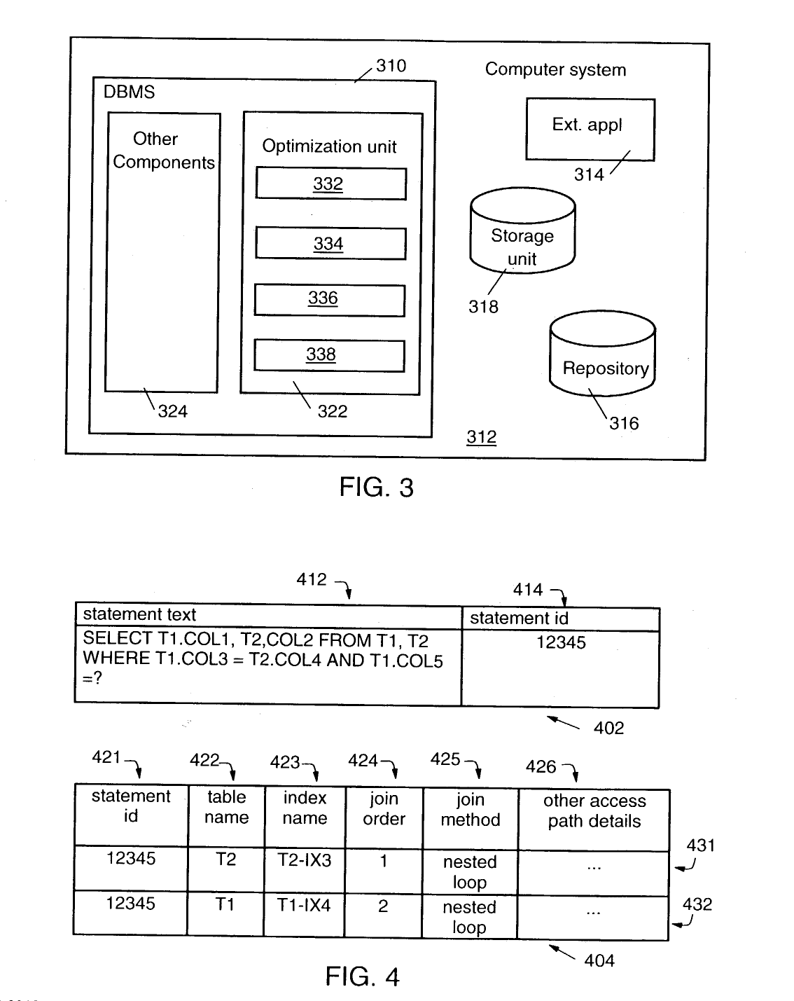

Now with reference to FIG. 3, there is depicted a block diagram illustrating a database management system 310 in a computer system environment 312 in accordance with the present invention.

The computer system environment 312 further includes an external application 314 that is separate from the database management system 310, a repository 316 and a storage unit 318, both for storing data. An application server, such as SAP, PeopleSoft or Siebel, may form the external application 314. The repository 316 and the storage unit 318 may be formed by non-volatile memory, such as a hard disk. It is acknowledged that the external application may be running on a different computer system that would be connected to the computer system 312 via a network. The same may apply to the repository 316 and the storage unit 318, which may be formed by one or more dedicated storage servers. Alternatively, the repository 316 could be an integral part of the storage unit 318 or vice versa.

The database management system 310 comprises an optimization unit 322 and other components 324. The other components are illustrated by one single block purely for the sake of clarity. For more details on the operation of a database management system and its components it is referred to FIG. 1 and the respective description.

The optimization unit 322 acts as a device for processing a query in the database management system 310 that generates an access plan for retrieving desired data from the computer storage 318 in response to the query. The optimization unit 322 comprises a first interface 332 for receiving a query in form of a predetermined representation, means 334 for deriving an identification from at least a portion of the representation, a second interface 336 for accessing a repository of user-specified hints in order to find a hint associated to the identification, and means 338 for generating the access plan in consideration of the user-specified hint, if a user-specified hint could be retrieved from the repository.

The first interface 332 may be formed by a communication link to at least on of the other components 324, whereas the second interface 336 may be implemented by a communication link to the repository 316.

The means 34 for deriving an identification from at least a portion of the representation may be formed by a functional unit, such as a computer program, for computing a hash function, such as MD5, from the respective portion of the query's representation.

The means 338 for generating the access plan in consideration of the user-specified hint may be formed by a state of the art optimizer that is able to take into account user specified hints, which were, e.g., specified within the code of the query statements. According to the present invention, however, the user-specified hints are advantageously be taken from the repository 316 and are kept completely independent from the external application issuing the queries.

Now with reference to FIG. 4, there is depicted an example on how the hints can be specified using database tables, namely a first table 402 and a second table 404 to store the specification in accordance with the present invention. The first table 402 comprises a first column 412 named “statement text” and a second column 414 named “statement id”. By way of example, one data row is provided in the first table 402, showing a statement text and a statement id (identification).

The second table 404 includes six columns 421, 422, 423, 424, 425 and 426, being named “statement id”, “table name”, “index name”, “join order”, “join method” and “other access path details”, respectively, whereby the sixth column 426 is a placeholder for one or more columns provided to keep additional information.

It is assumed that the optimization unit selects an inefficient access path for the statement:

SELECT T1.COL1, T2.COL2 FROM T1, T2 WHERE T1.COL3 = T2.COL4 AND T1.COL5 = ?

In order to provide a user-specified hint, a statement id is generated that is associated to the statement text, as illustrated by the first table 402.

The generated statement id is then used to identify the user-specified hint in the second table 404 in order to instruct the optimizer to use the following access path:

use nested loop method to join T2 to T1

first access T2, then T1

use index T2-IX3 to access T2

use index T1-IX4 to access T1

Therefore the following entries are entered into the second table 404: The generated statement id “12345” is entered in both, the first and second row 431, 432 of the first column 421, since two columns are needed to fully describe the user-specified hint. In the first row 431, in the third column 423 it is specified that the index “T2-IX3” is to be used to access Table T2. Correspondingly, in the second row 432, in the third column 423 it is specified that the index “T1-IX4”is to be used to access Table T1. The join order in the fourth column dictates that first the table T2 has to be accessed as specified by the number “1”. The join method is a nested loop in both cases.

The tables' content is given for demonstration purposes only. As different DBMSs implement different access mechanisms the tables' structure will be DBMS specific. In particular, the first table 402 may be omitted or only a temporary table, since in operation the statement id may be generated from the statement text or a representation thereof whenever a query is initiated by the external application.

The present invention can be realized in hardware, software, or a combination of hardware and software. Any kind of computer system—or other apparatus adapted for carrying out the methods described herein—is suited. A typical combination of hardware and software could be a general—purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

In summary, the present invention advantageously provides an application independent way of specifying optimizer hints, i.e., the hints are stored outside of the application itself. In order to correlate them with particular query statements the statement text itself or any representation is stored together with the associated hints. The store can be either an operating system file or a database table. After the statement text is entered it may be normalized and compressed in a bijective way, in order to get a compact, unique hint identifier.

In operation the DBMS (Database Management System) normalizes and compresses the statement text or its representation before execution in the same bijective way that has been used at hint specification time. It is acknowledged that this process needs to ensure that two statements that differ from each other in details that are irrelevant for access path selection such as the number of imbedded ‘cosmetic’ blanks or comments get mapped to the same value. If the obtained value matches any hint identifier, the cost based optimization is ignored and the corresponding hints are used.

Advantageously, according to the method and device of the present invention it is avoided to change the application and/or to update the optimizer's input, i.e. database objects statistics, in order to improve database performance. In particular, the method and device in accordance with the present invention supersedes finding all the places in an external application where the problem statement is coded and modifying the statement in all those places. Even large packaged enterprise applications can advantageously be performance tuned by using user-specified hints at one central point. Now it is even possible to treat query statements the same, which are generated ‘on the fly’, e.g., dynamic SQL. It should be noted that the present invention works for both static and dynamic SQL.

It will be appreciated that variations of some elements are possible to adapt the invention for specific conditions or functions. The concepts of the present invention can be further extended to a variety of other applications that are clearly within the scope of this invention.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of processing a query in a database management system that generates an access plan to retrieve desired data from computer storage in response to the query, the method comprising:
deriving an identification from at least a portion of a received query or representation thereof; and
generating the access plan in consideration of a hint associated with said identification, if such a hint is available from a repository of hints.

2. The method of claim 1, further comprising:
checking a flag indicating whether or not hints are to be considered for said identification.

3. The method of claim 1, wherein said representation of said received query is semantically equivalent to the query as specified in an external application.

4. The method of claim 3, wherein said representation of said received query is identical to said query as specified in said external application.

5. The method of claim 3, wherein said query is specified in said external application in the form of an SQL statement.

6. The method of claim 3, wherein said repository is kept separate from said external application.

7. The method of claim 1, wherein the step of deriving an identification from at least a portion of said query or representation thereof includes executing a digest function.

8. The method of claim 7, wherein said digest function is formed by a hash function.

9. The method of claim 1, wherein said repository is formed by at least one of the group of: an operating system file, a database table, and internal memory.

10. The method of claim 1, further comprising generating the access plan without any hints if the associated hint is not available.

11. The method of claim 1, wherein the identification is derived using a transformation applied to the query or representation thereof, said transformation also having been applied to an identical previous query or representation thereof at the time of creation of said hint associated with said query or representation thereof.

12. A device for processing a query in a database management system that generates an access plan to retrieve desired data from computer storage in response to the query, the device comprising:
a deriving component for deriving an identification from at least a portion of a representation of a received query; and
a generating component for generating the access plan in consideration of a hint associated with said identification, said hint found in a repository of hints.

13. The device of claim 12, further comprising a checking component for checking a flag indicating whether or not hints are to be considered for said identification.

14. The device of claim 12, wherein said representation is semantically equivalent to the query as specified in an external application.

15. The device of claim 14, wherein said representation is identical to said query as specified in said external application.

16. The device of claim 14, wherein said query is specified in said external application in form of an SQL statement.

17. The device of claim 14, wherein said repository is kept separate from said external application.

18. The device of claim 12, wherein said deriving component includes a component for executing a digest function.

19. The device of claim 18, wherein said digest function is formed by a hash function.

20. The device of claim 12, wherein said repository is formed by at least one of the group of: an operating system file, a database table, and internal memory.

21. The device of claim 12, wherein said generating component for generating the access plan includes a query optimizer.

22. A computer readable medium including program instructions for causing a computer to perform a method comprising:
deriving an identification from at least a portion of a received predetermined representation of a query;
accessing a repository of user-specified hints in order to find a hint associated with said identification; and
generating the access plan in consideration of the user-specified hint, if a user-specified hint could be retrieved from said repository.

23. The computer readable medium of claim 22, wherein the method further comprises:
checking a flag indicating whether or not hints are to be considered for said identification.

24. The computer readable medium of claim 22, wherein said representation of said received query is semantically equivalent to the query as specified in an external application.

25. The computer readable medium of claim 24, wherein said representation of said received query is identical to said query as specified in said external application.

26. The computer readable medium of claim 24, wherein said query is specified in said external application in the form of an SQL statement.

27. The computer readable medium of claim 24, wherein said repository is kept separate from said external application.

28. The computer readable medium of claim 22, wherein the deriving an identification from at least a portion of said query or representation thereof includes executing a digest function.

29. The computer readable medium of claim 28, wherein said digest function is formed by a hash function.

30. The computer readable medium of claim 22, wherein said repository is formed by at least one of the group of: an operating system file, a database table, and internal memory.

31. The computer readable medium of claim 22, further comprising generating the access plan without any hints if the associated hint is not available.

32. The computer readable medium of claim 22, wherein the identification is derived using a transformation applied to the query or representation thereof, said transformation also having been applied to an identical previous query or representation thereof at the time of creation of said hint associated with said query or representation thereof.

33. The computer readable medium of claim 22, wherein said generating the access plan is performed by a query optimizer.
